(19) United States
(12) Patent Application Publication
(10) Pub. No.: US 2014/0071461 A1
(43) Pub. Date: Mar. 13, 2014

(54) Precise Interpolation Method on Optical Encoder

(71) Applicant: Sung Ping Sun, Norwalk, CT (US)

(72) Inventor: Sung Ping Sun, Norwalk, CT (US)

(21) Appl. No.: 13/606,142

(22) Filed: Sep. 7, 2012

(51) Int. Cl. G01B 11/00

(52) U.S. Cl. CPC G01B 11/002
USPC 356/620

(57) ABSTRACT

We propose a high precision positional system that uses optical encoder and photo sensor to provide coarse position. We add a camera, secured to photo sensor, and set the magnification to view a few dozen marks on the encoder. With vision processing we can obtain precise interpolation with respect to pitch.

### REFERENCES CITED

U. S. Patent documents

| | | |
|---|---|---|
| 8,173,951 | May 2012 | Takahashi |
| 8,097,842 | January 2012 | Thor et al |
| 7,554,079 | June 2009 | Rai et al |
| 7,435,945 | October 2008 | Shinomura et al |
| 6,928,386 | August 2005 | Hasser |
| 6,835,924 | December 2004 | Kawano et al |
| 6,355,927 | March 2002 | Snyder |
| 5,844,814 | December 1998 | Chliwnyj et al |

### BACKGROUND

To determine the position/displacement of a degree of freedom, the prevailing practice is to mount optical encoder against a photo sensor to decipher relative position. The optical encoder has repeating marks with precise regularity so that the system can determine how far the mechanism has traveled. To obtain higher precision, engineers obtain electrical signal from photo sensor and interpolate the voltage, converting it to position. This approach depends on the property that all encoder marks are perfectly identical. Which translates into identical electrical output.

There are proposals to enhance photo sensor signal, using various novelty methods. Some of these approaches involve array of sensors, some utilize phase, some use grating to regulate light, one even makes use of polarized light. All these methods still deal with encoder marks locally (one on each side of the photo sensor).

### DESCRIPTION

We recognize that the defining property of optical encoder is the pitch, which goes beyond neighboring 2 marks. So a system that utilizes the pitch must be able to include several marks.

To realize better interpolation, we use camera, which can process a few dozen encoder marks in one field of view. This camera assist the photo sensor and use vision processing to determine the interpolated position, which is calculated based on the pitch of encoder scale.

1. We mount a camera, with proper optics and lighting, near the photo sensor. We fix the magnification to include several dozen marks (16-49 marks) in the same field of view.

2. We choose a point (for example, center of the view) to be the origin or reference.

3. The camera takes a picture. The system analyzes the picture of these marks (for example, using Fourier transform), and reduces the pattern to cos(k(x+δ)), where k is the wave number, and δ is the desired displacement.
